(19) United States
(12) Patent Application Publication
(10) Pub. No.: US 2004/0203629 A1
(43) Pub. Date: Oct. 14, 2004

(54) Intelligent interactive voice response unit

(76) Inventors: Anthony J. Dezonno, Bloomingdale, IL (US); Jeffrey D. Hodson, Wheaton, IL (US); Joseph Bloom, Libertyville, IL (US); David Funck, Wheaton, IL (US); Eric James, Elgin, IL (US); Michael Peters, Downers Grove, IL (US); Mark J. Powers, Carol Stream, IL (US); Craig R. Shambaugh, Wheaton, IL (US); Dave Mosquera, West Chicago, IL (US); Nayel Saleh, Round Lake, IL (US)

Correspondence Address: WELSH & KATZ, LTD, 120 S RIVERSIDE PLAZA, 22ND FLOOR, CHICAGO, IL, 60606, US

(21) Appl. No.: 10/090,499

(22) Filed: Mar. 4, 2002

(51) Int. Cl. H04M 3/42

(52) U.S. Cl. 455/414.1; 455/415

(57) ABSTRACT

A method and apparatus for processing calls in a call processing center provided for support of enterprise activities of an organization. The method includes the steps of receiving a query about the enterprise activities of the organization from a caller through the call center, translating the query into voice extensible mark-up language, forming an answer to the translated query within an artificial intelligence engine and providing the determined answer to the caller.

### FIELD OF THE INVENTION

The field of the invention relates to communication systems and more particularly to call centers.

### BACKGROUND OF THE INVENTION

Call-centers are generally known. A call-center is typically used wherever a large number of calls must be handled for some common enterprise. Typically, the calls of the enterprise are routed through the call-center as a means of processing the calls under a common format.

Call-centers typically include at least three elements: an automatic call distributor (ACD), a group of agents for handling the calls, and a host computer containing customer information. The individual agents of the groups of agents are each typically provided with a telephone console and a computer terminal. The telephone terminal receives customer calls distributed to the agent by the ACD. The terminal may be used to retrieve customer records from the host.

Call-centers are typically automated in the delivery of calls to agents and in the retrieval of customer records for use by agents. Features within the PSTT such as dialed number identification service (DNIS) and automatic number identification (ANI) may be used to determine not only the destination of the call, but also the identity of the caller. DNIS and ANI information, in fact, may be delivered by the PSTN to the ACD in advance of call delivery.

Based upon the destination of the call and identity of the caller, the ACD may select the agent most qualified to service the call. By sending an identifier of the selected agent along with the identity of the caller to the host, the host may automatically retrieve and download customer records to the agent's terminal at the same instant as the call arrives.

While call-centers are effective, they are labor intensive and difficult to adapt to changing business environments. Accordingly, a need exists for a better way of servicing inquiries from callers.

### SUMMARY

A method and apparatus for processing calls in a call processing center provided for support of enterprise activities of an organization. The method includes the steps of receiving a query about the enterprise activities of the organization from a caller through the call center, translating the query into voice extensible mark-up language, forming an answer to the translated query within an artificial intelligence engine and providing the determined answer to the caller.

### BRIEF DESCRIPTION OF THE DRAWINGS

FIG. 1 is a block diagram of a call processing system under an illustrated embodiment of the invention; and

FIGS. 2a-b is a flow diagram of an example call flow processed by the system of FIG. 1.

### DETAILED DESCRIPTION OF AN ILLUSTRATED EMBODIMENT

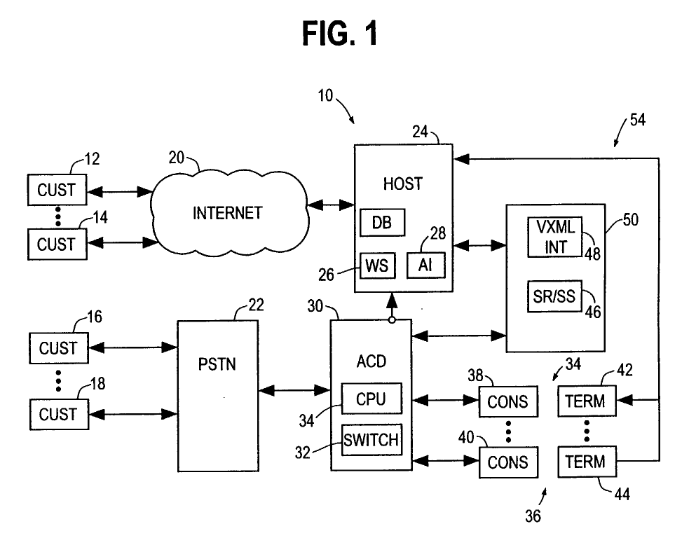

FIG. 1 depicts a call processing system 10, shown generally in accordance with an illustrated embodiment of the invention. Under the illustrated embodiment, calls may be received from clients 12, 14, 16, 18 under any of a number of different formats. For example, calls may be placed to the call processing system 10 using conventional telephones 16, 18 through the public switch telephone network (PSTN) 22. Alternately, calls may be delivered in the form of web pages or e-mails to a web site 26 of the call processing system 10 from the terminals 12, 14 of clients.

The call processing system 10 may be used by an organization (e.g., a merchant, a political organization, etc.) to setup call connections through the PSTN or Internet between an external client of the organization and an information resource of the organization for purposes of advancing the agenda of the organization.

For example, where the organization is a merchant, the message exchange system 10 may be structured around a matrix switch 32 and/or a website 26, that is provided to promote the wares of the merchant. The merchant may advertise its wares through television or newspaper ads. The ads may provide a telephone number associated with the switch 32 or the Internet address (i.e., the URL) of the website 26. Alternatively, the organization may set up links to the website 26 from search engines or from the websites of other merchants selling related merchandise.

In order to reduce the requirements for trained agents, a novel automatic agent 54 may be provided that is based upon the principles of artificial intelligence (AI). The automatic agent 54 may be structured to receive queries from customers and form answers under a voice extensible mark-up language (VXML) format. As used herein, forming an answer means correlating a query against a number of possible answers and selection of the most probable answer.

The automatic agent 54 differs from the prior use of AI in a number of regards. For example, the automatic agent 54 differs in its application of artificial intelligence to servicing calls in a call center 10. Prior art interactive voice response units (IVRs) have generally lacked the intelligence to answer questions and have typically been limited to menu presentation and to detection of menu selection.

The automatic agent 54 also differs in the coupling of artificial intelligence with voice recognition and speech synthesis. The coupling of artificial intelligence with voice recognition and speech synthesis results in a truly automatic call center.

The automatic agent 54 may include an artificial intelligence (AI) engine 28 and a VXML gateway 50. The VXML gateway 50, in turn, may include a speech recognition/speech synthesize (SR/SS) converter 46 and a VXML interpreter 48.

The SS/SR converter 46 may use any appropriate speech recognition application (e.g., Via Voice by IBM, Nuance 7 by Nuance, OpenSpeech Recognizer by Speechworks, etc.) to convert spoken words of customers 12, 14, 16, 18 into text. The spoken words may originate from a switched circuit call connection through the PSTN 22 or from a voice over Internet Protocol (VoIP) call arriving through the Internet.

The SS/SR converter 46 may also convert VXML received from the AI engine 28 through the VXML interpreter 48 into spoken words under an audible format. Conversion may be accomplished by applications from any of a number of suppliers (e.g., Speechify by Speechworks, Vocalizer by Nuance, Fonix, etc.). The spoken words, in turn, may be delivered to customers 12, 14, 16, 18 through the PSTN 22 or through the Internet under a VoIP format.

Text received from the SS/SR converter 46 may be converted into VXML within the VXML interpreter 48 for transfer to the AI engine 28. Alternatively, VXML from the AI engine 28 may be converted into text within the VXML interpreter 46 and transferred to the SS/SR converter 46 for conversion into an audible format.

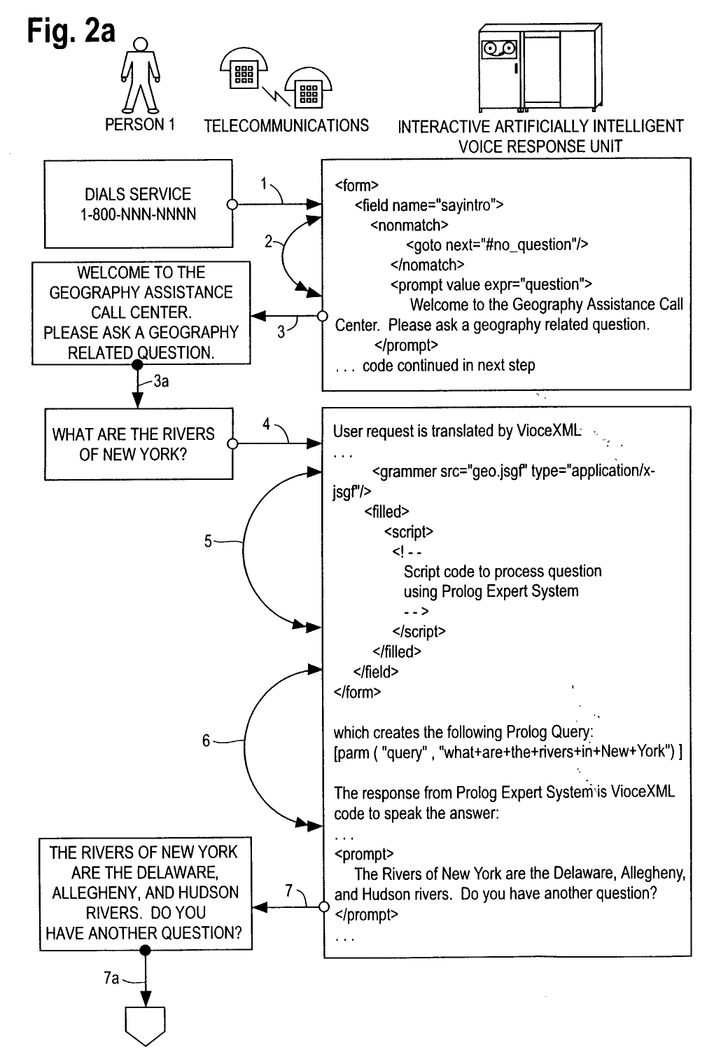

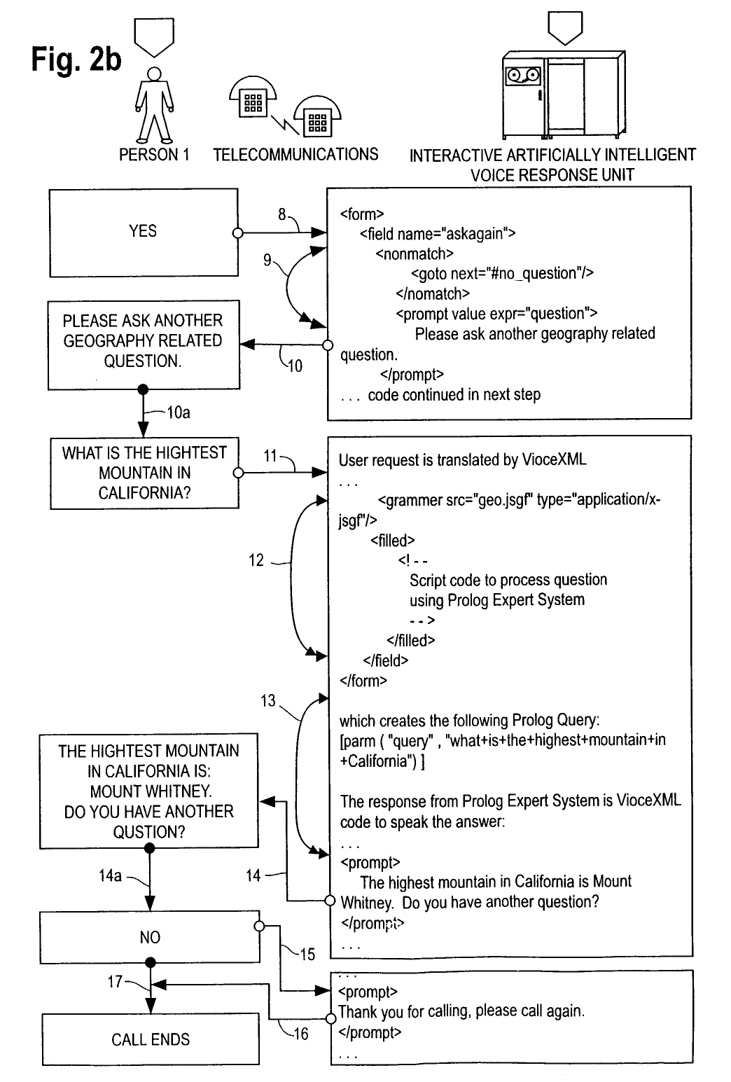

FIGS. 2a-b provide an example of the operation of a call processing system 10 (e.g., maintained by an organization providing geographic assistance). In the example of FIGS. 2a-b, the column on the left depicts caller activity and the column on the right depicts the VXML code generated by the automatic agent 54. The step number is shown incorporated into the lines joining boxes.

As a part of step #1, the caller enters the digits (e.g., 1-800-nnn-nnnn) to call the call processing center 10. In step #2, the call is connected to the automatic agent 54 and the automatic agent 54 generates the code shown to greet the caller. In step #3, the speech synthesizer generates the words “Welcome to the Geographic Assistance Call Center. Please ask a geography related question.” In step #4, the caller asks “What are the rivers of New York?” In step #5, the AI engine 28 translates the caller's question into the Prolog query [par=(“query”, “what+are+the+rivers+of +New+York”)] for processing within the AI engine 28. Once converted into a Prolog format, an answer may be formed within the AI engine 28 under any of a number of different methods.

In step #6, after retrieving the answer, the AI engine 28 creates the VXML code to answer the question. In step #7, the speech synthesizer audibly recites the response “The Rivers of New York are: the Delaware, Allegheny, and Hudson rivers. Do you have another question?” In step #8, the caller says “yes”. The VXML gateway 50 transfers the answer to the AI engine 28 and the AI engine 28 creates the code to ask the caller for the next question in step #9. In step #10, the speech synthesizer converts the response into the audible statement “Please ask another geography related question?”

In response, the caller asks “What is the highest mountain in California?” in step 11. The AI engine 28 converts the query into the Prolog query [parm(“query”, “What+is+the+highest+mountain+in+California”)]. The AI engine 28 forms an answer and creates the VXML code to answer the caller in step #13. In step #14, the voice synthesizer forms the audible response “The highest mountain in California if Mount Whitney. Do you have another question?” In step #15, the automatic agent 54 detects an negative response. In step #16, the automatic agent 54 provides the audible response “Thank you for calling, please call again” followed by the end of call at step #17.

The AI engine 28 may be based upon any appropriate declarative or logic programming language (e.g., Prolog, LDL, etc.) adapted to process queries and provide responses under VXML. The programming of the AI engine 28 may implement a subset of second order logic (that is, it can deal with sets as well as elemental propositions), and may be structured to permit propositions that lie well outside the boundaries of any classification of formal logical systems.

Further, the AI engine 28 may function as a frame or rule-based system. The inferencing capabilities of the AI engine 28 may allow the incorporation of forward and backward chaining, pattern matching and constraint resolution systems and subsystems.

In order to optimize the interaction of the customer 12, 14, 16, 18 with the organization, the AI engine may incorporate the expertise and inputs normally associated with a live agent 34, 36. The expertise of the agent 34, 36 may involve a comprehensive knowledge of the enterprise activities of the organization. The inputs of the agents 34, 36 may include a knowledge of the identity of the source of the query (e.g., based upon ANI for a telephone call, upon URL for a call through the Internet, etc.). The inputs of the agents 34, 36 may also include personal information of the source of the call based upon prior contacts with the organization.

As calls arrive within the call processing system, a call record may be created for each call for purposes of collecting call associated information. In the case of a call through the PSTN 22, call associated information may include ANI, DNIS information. In the case of a call through the Internet 20, call associated information may include a URL and/or identifiers of any web pages visited on the web site 26.

In the case of calls through the PSTN 22, the SR/SS 46 may function to convert between the audible format and text in support of a call. The VXML interpreter 48 may function to convert between the text format and the VXML format used by the AI engine 28.

In the case of a call through the Internet 20, web page documents may be received from customers 12, 14 and the VXML interpreter 48 may retrieve VXML from those documents for processing by the AI engine 28. The VXML interpreter 48 may also function to incorporate VXML responses from the AI engine 28 into documents that are delivered to customers 12, 14 in response to calls.

Calls may be preferentially routed to the automatic agent 54 or all calls may be initially routed to the automatic agent 54 with only exceptional calls routed to agents 34, 36. Exceptional calls may be calls from customers 12, 14, 16, 18 that prefer to deal with a specific agent or calls that cannot be resolved using the automatic agent 54.

In any case, the call record may be delivered to the automatic agent 54 at the same time the call is delivered to the automatic agent 54. The call record allows the AI engine 28 to assume a context within which the call may be processed. The context may be based upon inferences drawn from prior contacts with this customer 12, 14, 16, 18 or from other information drawn from the call record (e.g., number dialed, domain name found within the caller's URL, geographical location of caller, etc.).

The function and performance of the AI engine 28 differs from artificial intelligence prior devices for a number of reasons. For example, by limiting the universe of knowledge of the AI engine 28 to the agenda of the organization, questions that would otherwise by indeterminate may be generalized or otherwise “spun” to reflect the objectives of the organization without loss of function.

Further, by providing the AI engine 28 with the identity and contact history of a client, the AI engine 28 may inherently be able to duplicate prior successful conversational strategies. The ability to duplicate prior contacts allows the AI engine to be virtually indistinguishable from a live agent 34, 36.

As a person of skill in the art would recognize, an artificial intelligent engine of the prior art would not be considered functionally equivalent because of the prior art requirement that artificial intelligence engines be measurably objectively accurate in their ability of responding to queries. However, in a context of the call center, the objective of the AI 28 is to influence and serve the clients of the organization. As such, objectivity is not necessary to the functionality of the AI engine 28. Because of this difference in focus, it would be understood that the AI 28 is structurally and functionally different than prior art AI engines.

A specific embodiment of an automatic agent provided for controlling calls in a call processing system according to the present invention has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of processing calls in a call processing center processing calls in support of enterprise activities of an organization, such method comprising the steps of:
receiving a query about the enterprise activities of the organization from a caller through the call center;
translating the query into voice extensible mark-up language;
forming an answer to the translated query within an artificial intelligence engine; and
providing the determined answer to the caller.

2. The method of processing calls in the call processing center as in claim 1 further comprising receiving the query through a switched circuit connection.

3. The method of processing calls in the call processing center as in claim 2 wherein the step of receiving the query through the switched circuit connection further comprises recognizing spoken words of the caller.

4. The method of processing calls in the call processing center as in claim 1 wherein the step of providing the determined answer to the caller further comprises converting the provided answer into extensible mark-up language.

5. The method of processing calls in the call processing center as in claim 4 wherein the step of translating the provided answer into extensible mark-up language further comprises generating audible speech.

6. The method of processing calls in the call processing center as in claim 1 wherein the step of receiving the query further comprises detecting the query within an html document.

7. The method of processing calls in the call processing center as in claim 1 wherein the step of receiving the query further comprises detecting the query within an e-mail.

8. An apparatus for processing calls in a call processing center processing calls in support of enterprise activities of an organization, such apparatus comprising:
means for receiving a query about the enterprise activities of the organization from a caller through the call center;
means for translating the query into voice extensible mark-up language;
means for forming an answer to the translated query within an artificial intelligence engine; and
means for providing the determined answer to the caller.

9. The apparatus for processing calls in the call processing center as in claim 8 further comprising means for receiving the query through a switched circuit connection.

10. The apparatus for processing calls in the call processing center as in claim 9 wherein the means for receiving the query through the switched circuit connection further comprises means for recognizing spoken words of the caller.

11. The apparatus for processing calls in the call processing center as in claim 8 wherein the means for providing the determined answer to the caller further comprises means for converting the provided answer into extensible mark-up language.

12. The apparatus for processing calls in the call processing center as in claim 11 wherein the means for translating the provided answer into extensible mark-up language further comprises means for generating audible speech.

13. The apparatus for processing calls in the call processing center as in claim 8 wherein the means for receiving the query further comprises means for detecting the query within an html document.

14. The apparatus for processing calls in the call processing center as in claim 8 wherein the means for receiving the query further comprises means for detecting the query within an e-mail.

15. An apparatus for processing calls in a call processing center processing calls in support of enterprise activities of an organization, such apparatus comprising:
a voice extensible mark-up language interpreter adapted to translate a query about the enterprise activities of the organization from a caller into voice extensible mark-up language;
an artificial intelligence engine adapted to form an answer to the translated query within an artificial intelligence engine; and
a speech synthesizer adapted to provide the determined answer to the caller.

16. The apparatus for processing calls in the call processing center as in claim 15 further comprising a switched circuit connection adapted to receive the query.

17. The apparatus for processing calls in the call processing center as in claim 15 wherein the means for receiving the query further comprises means for detecting the query within an html document.

18. The apparatus for processing calls in the call processing center as in claim 15 further comprising a speech recognition application adapted to recognize spoken words of the caller.

19. The apparatus for processing calls in the call processing center as in claim 15 wherein the means for receiving the query further comprises a web site adapted to detect the query within an e-mail.

20. A method of processing calls in a call processing center, such method comprising the steps of:
receiving a text-based question from a caller;
converting the text-based question into a metaprogramming language understood by an artificial intelligence engine;
determining an answer to the question within the artificial intelligence engine;
providing the determined answer to the caller.

21. A method of processing calls in a call processing center, such method comprising the steps of:
providing an artificial intelligence engine with a database of customer products;
receiving a text-based question about a customer product from a caller;
converting the text-based question into a metalanguage understood by an artificial intelligence engine;
determining an answer to the question within the artificial intelligence engine;
providing the determined answer to the caller.
